(19) United States
(12) Patent Application Publication
(10) Pub. No.: US 2023/0314885 A1
(43) Pub. Date: Oct. 5, 2023

(54) LIQUID CRYSTAL DISPLAY DEVICE

(71) Applicant: Sharp Display Technology Corporation, Kameyama City (JP)

(72) Inventors: Yasuhiro HASEBA, Kameyama City (JP); Takako KOIDE, Kameyama City (JP)

(21) Appl. No.: 18/126,338

(22) Filed: Mar. 24, 2023

(30) Foreign Application Priority Data
Mar. 29, 2022 (JP) 2022-053853

(51) Int. Cl. G02F 1/1362; C09K 19/30; C09K 19/06

(52) U.S. Cl. CPC G02F 1/136222; C09K 19/3003; C09K 19/062; C09K 19/3098; C09K 2019/3004

(57) ABSTRACT

A liquid crystal display device includes, in sequence, a backlight, a first substrate including a color filter layer, a liquid crystal layer containing a liquid crystal composition, and a second substrate. The liquid crystal composition contains a liquid crystal compound having a phenyl group and a conjugated bond group. The phenyl group has a halogen atom substituted for at least one hydrogen atom. The conjugated bond group is conjugated with the phenyl group to form a continuous conjugated system.

### BACKGROUND

### 1. Field

The present disclosure relates to a liquid crystal display device.

### 2. Description of the Related Art

A liquid crystal display device is a display device that utilizes a liquid crystal composition for display. In a typical display method thereof, the amount of light transmitted is controlled by applying a voltage to the liquid crystal composition enclosed between a thin-film-transistor (TFT) substrate and an opposite substrate, and changing the alignment state of a liquid crystal compound in the liquid crystal composition in accordance with the applied voltage. Such liquid crystal display devices are used in a wide range of fields by taking advantage of their features, such as thinness, light weight, and low power consumption.

As a technique related to liquid crystal display devices, for example, Japanese Unexamined Patent Application Publication No. 9-124529 discloses a 2,6-di-tert-butylphenol compound suitable as a stabilizer for liquid crystal compounds.

International Publication No. 2012/050177 discloses a liquid crystal display device including a liquid crystal cell that includes a pair of substrates and a liquid crystal layer held between the pair of substrates, in which at least one substrate of the pair of substrates includes an electrode, an underlying film disposed on a side of the electrode adjacent to the liquid crystal layer, and a polymer layer disposed on a side of the underlying film adjacent to the liquid crystal layer and configured to control the alignment of adjacent liquid crystal molecules, the underlying film is formed from a photoactive material, the polymer layer is formed by polymerization of a monomer added to the liquid crystal layer, and the liquid crystal layer contains liquid crystal molecules having, in its molecular structure, a multiple bond other than conjugated double bonds of a benzene ring.

According to studies by the inventors, liquid crystal compounds added to liquid crystal compositions in order to increase the response speeds of liquid crystal display devices easily cause a decrease in voltage holding ratio (VHR) due to light irradiation. For this reason, components of liquid crystal compositions are limited in order to maintain the reliability of liquid crystal display devices. Thus, the response speeds of liquid crystal display devices are reaching their limits, resulting in a difficulty in improving the response speed. As described above, there is still room for improvement in liquid crystal display devices that can have a smaller decrease in VHR and a higher response speed.

Japanese Unexamined Patent Application Publication No. 9-124529 does not discuss a liquid crystal display device that can have a smaller decrease in VHR and a higher response speed.

The present disclosure has been made in light of the above-mentioned current situation, and it is desirable to provide a liquid crystal display device that can have a smaller decrease in VHR and a higher response speed.

### SUMMARY

According to an aspect of the disclosure, there is provided a liquid crystal display device including, in sequence, a backlight, a first substrate including a color filter layer, a liquid crystal layer containing a liquid crystal composition, and a second substrate, in which the liquid crystal composition contains a liquid crystal compound having a phenyl group and a conjugated bond group, the phenyl group having a halogen atom substituted for at least one hydrogen atom, and the conjugated bond group being conjugated with the phenyl group to form a continuous conjugated system.

### BRIEF DESCRIPTION OF THE DRAWINGS

FIG. 1 is a schematic cross-sectional view of a liquid crystal display device according to a first embodiment;

FIG. 2 is a schematic cross-sectional view of a liquid crystal display device according to a second embodiment; and

FIG. 3 is a graph illustrating the results of VHR measurement in Example 1, Reference example 1, and Comparative example 1.

### DESCRIPTION OF THE EMBODIMENTS

Embodiments of the present disclosure will be described in more detail below with reference to the attached drawings. The present disclosure, however, is not limited to these embodiments.

### Definition of Terms

In this specification, the term “viewing surface side” refers to a side closer to the screen (display surface) of a liquid crystal display device, and the term “back surface side” refers to a side farther from the screen (display surface) of the liquid crystal display device.

### First Embodiment

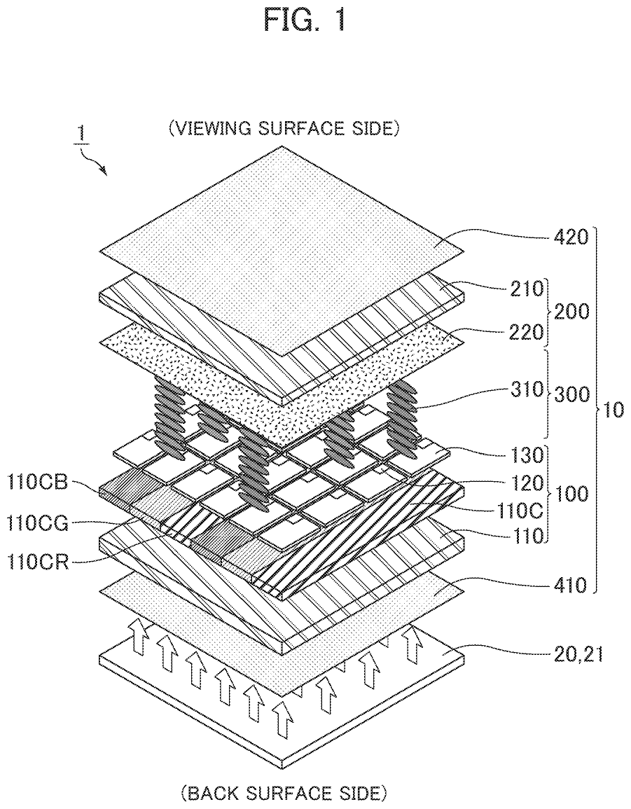

FIG. 1 is a schematic cross-sectional view of a liquid crystal display device according to a first embodiment. As illustrated in FIG. 1, a liquid crystal display device 1 according to the present embodiment includes, in sequence, a backlight 20, a first substrate 100 including a color filter layer 110C, a liquid crystal layer 300 containing a liquid crystal composition, and a second substrate 200, in which the liquid crystal composition contains a liquid crystal compound (hereinafter, also referred to as a “first liquid crystal compound”) having a phenyl group and a conjugated bond group, the phenyl group having a halogen atom substituted for at least one hydrogen atom, and the conjugated bond group being conjugated with the phenyl group to form a continuous conjugated system.

The first liquid crystal compound has a low viscosity. The first liquid crystal compound has large refractive index anisotropy (Δn), so that the cell thickness (thickness of the liquid crystal layer) can be reduced. Since the liquid crystal layer 300 contains the first liquid crystal compound, the response speed of the liquid crystal display device 1 can be increased. The first liquid crystal compound has the property that the initial VHR is high but the VHR decreases due to backlight aging. In the present embodiment, however, since the first substrate 100 including the color filter layer 110C is disposed on the back surface side of the liquid crystal layer 300, the intensity of light emitted from the backlight 20 to the liquid crystal layer 300 is about ⅓ or less of that in the typical structure. Thus, although the liquid crystal layer 300 included in the liquid crystal display device 1 according to the present embodiment contains the first liquid crystal compound, the decrease in VHR can be reduced.

Each component of the liquid crystal display device of the present embodiment will be described below.

The liquid crystal display device 1 according to the present embodiment includes a liquid crystal panel 10 and the backlight 20 disposed on the back surface side of the liquid crystal panel 10. The liquid crystal panel 10 includes, in order from the back surface side to the viewing surface side, a first polarizer 410, the first substrate 100, a first alignment film, the liquid crystal layer 300, a second alignment film, the second substrate 200, and a second polarizer 420. Here, a unit composed of the first substrate 100, the first alignment film, the liquid crystal layer 300, the second alignment film, and the second substrate 200 is also referred to as a “liquid crystal cell”. The backlight 20 includes a light source 21.

The first substrate 100 includes a support substrate 110, the color filter layer 110C, thin-film transistors (TFTs) 120 as switching elements, and pixel electrodes 130. The color filter (CF) layer 110C includes a red color filter 110CR, a green color filter 110CG, and a blue color filter 110CB. A structure in which a CF layer is disposed on the side of a substrate where TFTs are arranged, as in the present embodiment, is also referred to as a “CF-on-array (COA) structure”.

The second substrate 200 includes a support substrate 210 and a common electrode 220 disposed on a side of the support substrate 210 adjacent to the liquid crystal layer 300.

The support substrates 110 and 210 may be transparent substrates. Examples thereof include glass substrates and plastic substrates.

The color filter layer 110C has a structure in which the red color filter 110CR, the green color filter 110CG, and the blue color filter 110CB are arranged in-plane. Each of the red color filter 110CR, the green color filter 110CG, and the blue color filter 110CB is composed of, for example, a pigment-containing transparent resin. Typically, a combination of the red color filter 110CR, the green color filter 110CG, and the blue color filter 110CB is disposed in each pixel, and a desired color is obtained in each pixel by mixing colors while the amounts of colored light beams passing through the red color filter 110CR, the green color filter 110CG, and the blue color filter 110CB are controlled.

As illustrated in FIG. 1, the first substrate 100 includes, on the support substrate 110, multiple gate lines extending in parallel to each other and multiple source lines extending in parallel to each other in a direction intersecting with the gate lines with a gate insulator interposed between the gate lines and the source lines. The gate lines and the source lines are arranged in a grid pattern as a whole so as to define the individual pixels. TFTs 120 are arranged at the respective intersections of the gate lines and the source lines.

Each of the TFTs 120 is coupled to a corresponding one of the gate lines and a corresponding one of the source lines. Each TFT 120 serves as a three-terminal switch including a gate electrode, which is a portion of the gate line, extending from the corresponding gate line, a source electrode, which is a portion of the source line, extending from the corresponding source line, a drain electrode coupled to a corresponding one of the pixel electrodes 130, and a thin-film semiconductor layer. The source electrodes and the drain electrodes are arranged at the identical source wiring layer where the source lines are arranged. The gate electrodes are arranged at the identical gate wiring layer where the gate lines are arranged.

The thin-film semiconductor layer of each TFT 120 includes, for example, a high-resistance semiconductor layer composed of amorphous silicon, polysilicon, or the like, and a low-resistance semiconductor layer composed of, for example, n+ amorphous silicon, which is amorphous silicon doped with an impurity such as phosphorus. Alternatively, an oxide semiconductor layer, such as a zinc oxide layer, may be used as the thin-film semiconductor layer.

The gate insulator is, for example, an inorganic insulating film. Examples of the inorganic insulating film that can be used include inorganic films (relative dielectric constant ε=about 5 to about 7), such as silicon nitride (SiNₓ) films and silicon oxide (SiO₂) films; and laminated films thereof.

Each of the gate wiring layer and the source wiring layer is formed of, for example, a single layer or multiple layers of a metal, such as copper, titanium, aluminum, molybdenum, or tungsten, or an alloy thereof. The gate lines, the source lines, and various wirings and electrodes included in the TFTs 120 can be formed by forming a single layer or multiple layers of a metal, such as copper, titanium, aluminum, molybdenum, or tungsten or an alloy thereof, by sputtering and then patterning the resulting layer(s) by photolithography or the like. Among these various wirings and electrodes, those formed at the same layer can be produced efficiently by using the same material.

The pixel electrodes 130 are electrodes disposed in regions (pixel regions) each surrounded by two adjacent gate lines and two adjacent source lines. Each pixel electrode 130 is disposed so as to be superimposed a corresponding one of the pixel regions. Each pixel electrode 130 is electrically coupled to a corresponding one of the source lines with the thin-film semiconductor layer, included in the TFT 120, interposed therebetween. The pixel electrode 130 is set to a potential corresponding to a data signal supplied through the corresponding TFT 120.

The common electrode 220 is an electrode disposed on substantially the entire surface, excluding a specific portion, regardless of the pixel boundaries. A common signal maintained at a predetermined value is supplied to the common electrode 220 to maintain the common electrode 220 at a predetermined potential.

Examples of a material for the pixel electrodes 130 and the common electrode 220 include indium tin oxide (ITO) and indium zinc oxide (IZO).

The liquid crystal layer 300 contains a liquid crystal composition. The liquid crystal composition contains at least one liquid crystal compound. The term “liquid crystal compound” refers to a compound in which a liquid crystal phase, such as a nematic phase or a smectic phase, appears at a low temperature, such as 70° C.). The liquid crystal compound has a rigid portion (mesogenic group) that contributes to the development of liquid crystallinity. The amount of light transmitted can be controlled by applying a voltage to the liquid crystal layer 300 and changing the alignment state of the liquid crystal compound in the liquid crystal composition in accordance with the applied voltage.

The liquid crystal compound may have a positive or negative value of dielectric anisotropy (Δε) defined by the following formula (L). A liquid crystal compound having positive dielectric anisotropy is also referred to as a “positive liquid crystal”, and a liquid crystal compound having negative dielectric anisotropy is also referred to as a “negative liquid crystal”. Note that the direction of the long axis of a liquid crystal compound is the direction of the slow axis. The liquid crystal compound is homogeneously aligned in a state where no voltage is applied (voltage non-applied state). The direction of the long axis of the liquid crystal compound in the voltage non-applied state is also referred to as the direction of the initial alignment of the liquid crystal compound.

Δε=(dielectric constant in direction of long axis of liquid crystal molecule)−(dielectric constant in direction of short axis of liquid crystal molecule) (L)

The liquid crystal composition contains a first liquid crystal compound having a phenyl group (benzene ring) and a conjugated bond group (conjugated multiple bonds), the phenyl group having a halogen atom substituted for at least one hydrogen atom, and the conjugated bond group being conjugated with the phenyl group to form a continuous conjugated system. The liquid crystal composition containing the first liquid crystal compound is hereinafter also referred to as “liquid crystal composition A”.

A liquid crystal compound having the same structure as the first liquid crystal compound, except that the phenyl group having a halogen atom substituted for at least one hydrogen atom is an unsubstituted phenyl group, is hereinafter also referred to as “liquid crystal compound R”. A liquid crystal composition containing the liquid crystal compound R is hereinafter also referred to as “liquid crystal composition R”.

Both of the liquid crystal composition A and the liquid crystal composition R have low viscosity and can improve the response speed of the liquid crystal display device. Since both of the liquid crystal composition A and the liquid crystal composition R have large refractive index anisotropy (Δn), it is possible to reduce the cell thickness (the thickness of the liquid crystal layer) and to improve the response speed of the liquid crystal display device.

When these liquid crystal compositions have the same dielectric anisotropy (Δε), a decrease in VHR after backlight aging is reduced in a liquid crystal display device that includes a liquid crystal layer containing the liquid crystal composition A, compared with a liquid crystal display device that includes a liquid crystal layer containing the liquid crystal composition R. However, in a typical structure in which a CF layer is disposed across a liquid crystal layer from a backlight, a decrease in VHR after backlight aging is caused, and it is difficult to reduce the decrease in VHR even when the liquid crystal composition A is used. In the present embodiment, the placement of the CF layer 110C closer to the backlight 20 than the liquid crystal layer 300 and the use of the liquid crystal composition A enable a smaller decrease in VHR even after backlight aging while the response speed is improved.

As described above, the first liquid crystal compound is useful from the viewpoints of increasing the refractive index anisotropy (Δn) of the liquid crystal composition, increasing the dielectric anisotropy, extending the nematic phase temperature range, and reducing the viscosity, and can increase the response speed of the liquid crystal display device 1. However, the first liquid crystal compound has particularly poor light stability and thus is not used or is used in a very limited manner in a TFT-containing liquid crystal display device that may have a high VHR. In contrast, in the present embodiment, the color filter layer 110C is disposed between the backlight 20 and the liquid crystal layer 300. Thus, the color filter layer 110C enables the attenuation of light incident on the liquid crystal layer 300 from the backlight 20, resulting in a smaller decrease in VHR due to light irradiation.

Japanese Unexamined Patent Application Publication No. 9-124529 does not discuss a liquid crystal display device having a smaller decrease in VHR even after backlight aging while the response speed is improved. In addition, even when the stabilizer described in Japanese Unexamined Patent Application Publication No. 9-124529 is used, the VHR decreases depending on the application of the liquid crystal display device, and there remains a problem in reliability against light.

Japanese Unexamined Patent Application Publication No. 9-124529 aims to improve the light resistance of the material. In the present embodiment, it is possible to improve the VHR by reducing the intensity of the backlight that decreases the VHR. This enables the use of a low-light-resistant liquid crystal compound, such as the first liquid crystal compound and an increase in the concentration of the liquid crystal compound (first liquid crystal compound) in the liquid crystal composition, thereby improving the response speed.

Examples of the conjugated bond group of the first liquid crystal compound include a conjugated double bond group and a conjugated triple bond group. Specific examples thereof include a cyano group, a tolane group, an isothiocyanate group, and —C═C—C═C—. Examples of the halogen atom contained in the phenyl group of the first liquid crystal compound include a fluorine atom, a chlorine atom, a bromine atom, and an iodine atom, and the fluorine atom may be used. In this case, the decrease in the VHR of the liquid crystal display device 1 can be further reduced.

The first liquid crystal compound may have at least one of partial structures represented by the following general formulae (L1) to (L6). In this case, the decrease in VHR can be effectively reduced. The first liquid crystal compound may contain two or more of the partial structures represented by the following general formulae (L1) to (L6) in one compound, or may contain two or more compounds each having at least one of the partial structures represented by the following general formulae (L1) to (L6):

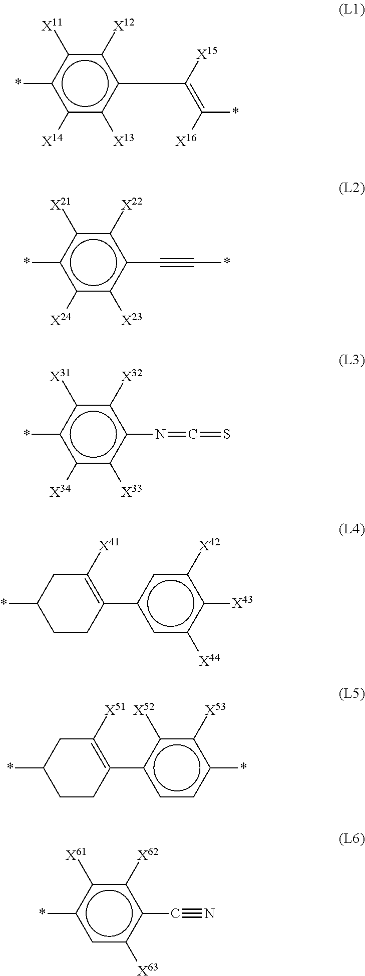

where in the above general formulae (L1) to (L6), X¹¹ to X¹⁶, X²¹ to X²⁴, X³¹ to X³⁴, X⁴¹ to X⁴⁴, X⁵¹ to X⁵³, and X⁶¹ to X⁶³ are each independently a hydrogen atom or a halogen atom, at least one of X¹¹ to X¹⁴ is a halogen atom, at least one of X²¹ to X²⁴ is a halogen atom, at least one of X³¹ to X³⁴ is a halogen atom, at least one of X⁴² to X⁴⁴ is a halogen atom, at least one of X⁵² or X⁵³ is a halogen atom, at least one of X⁶¹ to X⁶³ is a halogen atom, and each * is a binding position.

At least one of X¹¹ to X¹⁴ in general formulae (L1) to (L6) may be a fluorine atom. At least one of X²¹ to X²⁴ may be a fluorine atom. At least one of X³¹ to X³⁴ may be a fluorine atom. At least one of X⁴² to X⁴⁴ may be a fluorine atom. At least one of X⁵² or X⁵³ may be a fluorine atom. At least one of X⁶¹ to X⁶³ may be a fluorine atom.

A specific example of the first liquid crystal compound having the partial structure represented by general formula (L1) is a liquid crystal compound having a structure represented by any of the following general formulae (L1-1) to (L1-5).

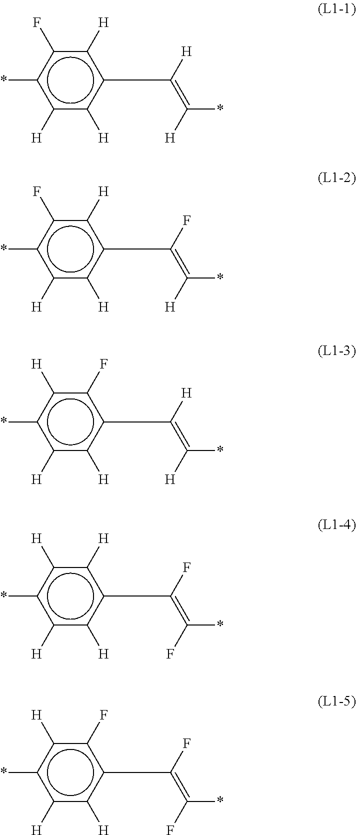

A specific example of the first liquid crystal compound having the partial structure represented by general formula (L2) is a liquid crystal compound having a structure represented by any of the following general formulae (L2-1) and (L2-2):

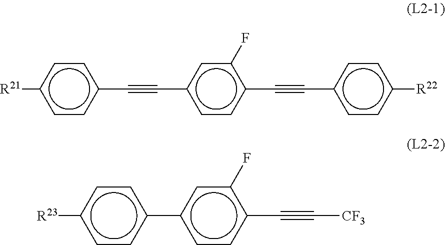

where in general formulae (L2-1) and (L2-2), R²¹ to R²³ each independently represent a hydrogen atom, a hydroxy group, or a monovalent organic group.

The monovalent organic group in general formulae (L2-1) and (L2-2) is preferably a monovalent organic group having about 1 to about 12 carbon atoms, more preferably an alkyl group having about 1 to about 12 carbon atoms. It is sufficient that the above monovalent organic group has a carbon atom and a hydrogen atom. The above monovalent organic group may have another atom, such as an oxygen atom or a halogen atom. In the above alkyl group, one —CH₂—CH₂— may be replaced with —CH═CH—, and at least one hydrogen atom may be replaced with a halogen atom. The alkyl group may have a substantially linear shape, a substantially branched shape, a substantially cyclic shape, or a shape of a combination thereof.

A specific example of the first liquid crystal compound having the partial structure represented by general formula (L3) is a liquid crystal compound having a structure represented by the following general formula (L3-1):

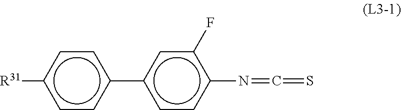

where in general formula (L3-1), R³¹ is a hydrogen atom, hydroxy group, or a monovalent organic group.

The monovalent organic group in general formula (L3-1) is preferably a monovalent organic group having 1 to 12 carbon atoms, more preferably an alkyl group having 1 to 12 carbon atoms. It is sufficient that the above monovalent organic group has a carbon atom and a hydrogen atom. The above monovalent organic group may have another atom, such as an oxygen atom or a halogen atom. In the above alkyl group, one —CH₂—CH₂— may be replaced with —CH═CH—, and at least one hydrogen atom may be replaced with a halogen atom. The alkyl group may have a substantially linear shape, a substantially branched shape, a substantially cyclic shape, or a shape of a combination thereof.

A specific example of the first liquid crystal compound having the partial structure represented by general formula (L4) is a liquid crystal compound having a structure represented by the following general formula (L4-1):

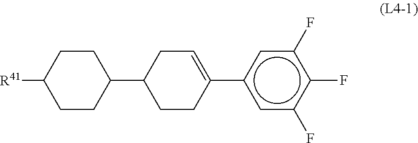

where in general formula (L4-1), R⁴¹ is a hydrogen atom, hydroxy group, or a monovalent organic group.

The monovalent organic group in general formula (L4-1) is preferably a monovalent organic group having about 1 to about 12 carbon atoms, more preferably an alkyl group having about 1 to about 12 carbon atoms, even more preferably an alkyl group having about 3 carbon atoms. It is sufficient that the above monovalent organic group has a carbon atom and a hydrogen atom. The above monovalent organic group may have another atom, such as an oxygen atom or a halogen atom. In the above alkyl group, one —CH₂—CH₂— may be replaced with —CH═CH—, and at least one hydrogen atom may be replaced with a halogen atom. The alkyl group may have a substantially linear shape, a substantially branched shape, a substantially cyclic shape, or a shape of a combination thereof.

A specific example of the first liquid crystal compound having the partial structure represented by general formula (L5) is a liquid crystal compound having a structure represented by the following general formula (L5-1):

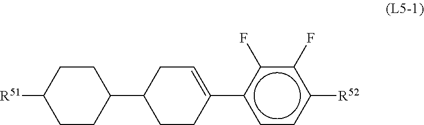

where in general formula (L5-1), R⁵¹ and R⁵² are each independently a hydrogen atom, a hydroxy group, or a monovalent organic group.

The monovalent organic group in general formula (L5-1) is preferably a monovalent organic group having about 1 to about 12 carbon atoms, more preferably an alkyl group having about 1 to about 12 carbon atoms, even more preferably an alkyl group having about 3 carbon atoms. It is sufficient that the above monovalent organic group has a carbon atom and a hydrogen atom. The above monovalent organic group may have another atom, such as an oxygen atom or a halogen atom. In the above alkyl group, one —CH₂—CH₂— may be replaced with —CH═CH—, and at least one hydrogen atom may be replaced with a halogen atom. The alkyl group may have a substantially linear shape, a substantially branched shape, a substantially cyclic shape, or a shape of a combination thereof.

A specific example of the first liquid crystal compound having the partial structure represented by general formula (L6) is a liquid crystal compound having a structure represented by the following general formula (L6-1):

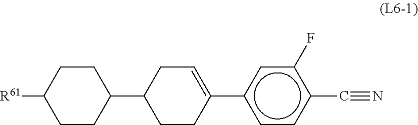

where in general formula (L6-1), R⁶¹ is a hydrogen atom, a hydroxy group, or a monovalent organic group.

The monovalent organic group in general formula (L6-1) is preferably a monovalent organic group having about 1 to about 12 carbon atoms, more preferably an alkyl group having about 1 to about 12 carbon atoms. It is sufficient that the above monovalent organic group has a carbon atom and a hydrogen atom. The above monovalent organic group may have another atom, such as an oxygen atom or a halogen atom. In the above alkyl group, one —CH₂—CH₂— may be replaced with —CH═CH—, and at least one hydrogen atom may be replaced with a halogen atom. The alkyl group may have a substantially linear shape, a substantially branched shape, a substantially cyclic shape, or a shape of a combination thereof.

The liquid crystal composition preferably contains about 3% or more by weight, more preferably about 7% or more by weight, even more preferably about 10% or more by weight, of the first liquid crystal compound based on the total amount of the liquid crystal composition. In this case, the response speed of the liquid crystal display device can be further increased. The liquid crystal composition may contain about 70% or less by weight of the first liquid crystal compound based on the total amount of the liquid crystal composition. In this case, the decrease in VHR can be effectively reduced.

The liquid crystal composition preferably contains about 3% or more by weight and about 70% or less by weight, more preferably about 7% or more by weight and about 70% or less by weight, even more preferably about 10% or more by weight and about 70% or less by weight, of the first liquid crystal compound based on the total amount of the liquid crystal composition.

The liquid crystal composition may contain a second liquid crystal compound having an alkenyl group that does not form a conjugated system. The second liquid crystal compound has the effect of reducing the viscosity of the liquid crystal composition. Thus, when the liquid crystal composition contains the second liquid crystal compound, a higher response speed can be obtained. However, an excessive second liquid crystal compound content leads to a large degree of a decrease in VHR due to light, making it difficult to use the composition in a TFT-including liquid crystal display device. In contrast, in the present embodiment, the color filter layer 110C is disposed between the liquid crystal layer 300 and the backlight 20. Thus, the color filter layer 110C enables the attenuation of light incident on the liquid crystal layer 300 from the backlight 20, resulting in a smaller decrease in VHR due to light irradiation. Thus, a larger amount of the second liquid crystal compound can be contained in the liquid crystal composition, effectively increasing the response speed of the liquid crystal display device.

The liquid crystal composition preferably contains about 51% or more by weight, more preferably about 60% or more by weight, even more preferably about 70% or more by weight, of the second liquid crystal compound based on the total amount of the liquid crystal composition. In this case, the response speed of the liquid crystal display device can be further increased. The liquid crystal composition may contain about 90% or less by weight of the second liquid crystal compound based on the total amount of the liquid crystal composition. In this case, the decrease in VHR can be effectively reduced.

The liquid crystal composition preferably contains about 51% or more by weight and about 90% or less by weight, more preferably about 60% or more by weight and about 90% or less by weight, even more preferably about 70% or more by weight and about 90% or less by weight, of the second liquid crystal compound based on the total amount of the liquid crystal composition.

Specifically, the second liquid crystal compound may have at least one of partial structures represented by the following general formulae (L7) and (L8). The second liquid crystal compound may contain two of the partial structures represented by the following general formulae (L7) and (L8) in one compound, or may contain two or more compounds each having at least one of the partial structures represented by the following general formulae (L7) and (L8):

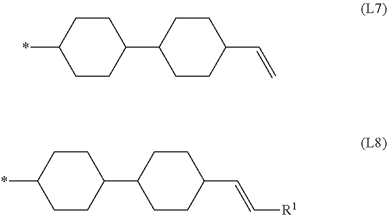

where R¹ in general formula (L8) is an alkyl group having about 1 to about 3 carbon atoms, and each * is a binding position.

In general formula (L8), at least one hydrogen atom of the alkyl group having about 1 to about 3 carbon atoms may be replaced with a halogen atom. The alkyl group having about 1 to about 3 carbon atoms may have a substantially linear shape, a substantially branched shape, or a substantially cyclic shape.

A specific example of the second liquid crystal compound having the partial structure represented by general formula (L7) is a liquid crystal compound having a structure represented by the following general formula (L7-1):

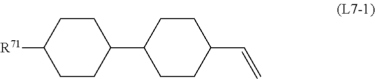

where in general formula (L7-1), R⁷¹ is a hydrogen atom, a hydroxy group, or a monovalent organic group.

The monovalent organic group in general formula (L7-1) is preferably a monovalent organic group having about 1 to about 12 carbon atoms, more preferably an alkyl group having about 1 to about 12 carbon atoms, even more preferably an alkyl group having about 3 carbon atoms. It is sufficient that the above monovalent organic group has a carbon atom and a hydrogen atom. The above monovalent organic group may have another atom, such as an oxygen atom or a halogen atom. In the above alkyl group, one —CH₂—CH₂— may be replaced with —CH═CH—, and at least one hydrogen atom may be replaced with a halogen atom. The alkyl group may have a substantially linear shape, a substantially branched shape, a substantially cyclic shape, or a shape of a combination thereof.

A specific example of the second liquid crystal compound having the partial structure represented by general formula (L8) is a liquid crystal compound having a structure represented by the following general formula (L8-1):

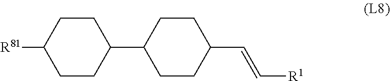

where in general formula (L8-1), R⁸¹ is a hydrogen atom, a hydroxy group, or a monovalent organic group, and R¹ is an alkyl group having about 1 to about 3 carbon atoms.

The monovalent organic group in general formula (L8-1) is preferably a monovalent organic group having about 1 to about 12 carbon atoms, more preferably an alkyl group having about 1 to about 12 carbon atoms, even more preferably an alkyl group having about 3 carbon atoms. It is sufficient that the above monovalent organic group has a carbon atom and a hydrogen atom. The above monovalent organic group may have another atom, such as an oxygen atom or a halogen atom. In the above alkyl group, one —CH₂—CH₂— may be replaced with —CH═CH—, and at least one hydrogen atom may be replaced with a halogen atom. The alkyl group may have a substantially linear shape, a substantially branched shape, a substantially cyclic shape, or a shape of a combination thereof.

R¹ in general formula (L8-1) is the same as R¹ in general formula (L8).

It is sufficient that the liquid crystal composition contains the first liquid crystal compound. The liquid crystal composition may contain both of the first liquid crystal compound and the second liquid crystal compound. Moreover, the liquid crystal composition may contain a liquid crystal compound other than the first liquid crystal compound or the second liquid crystal compound.

The first liquid crystal compound contained in the liquid crystal layer 300 may be a single compound or may contain two or more compounds. When the liquid crystal layer 300 contains the second liquid crystal compound, the second liquid crystal compound contained in the liquid crystal layer 300 may be a single compound or may contain two or more compounds.

The liquid crystal layer 300 may contain a polymer network. In this case, ions considered to be the cause of deterioration of the VHR are shielded by the polymer network and thus less likely to reach an electrode, so that the VHR can be improved.

The liquid crystal layer 300 may be formed by, for example, a one-drop-fill method. When the liquid crystal layer is formed by the one-drop-fill method, for example, the following process is employed. A sealing material is applied onto a surface of one of a pair of substrates (the first substrate 100 and the second substrate 200), and the liquid crystal composition is dropped onto a surface of the other substrate. After that, the pair of substrates is bonded to each other with the sealing material in a vacuum. Thereby, a liquid crystal layer can be formed in a region surrounded by the sealing material in a plan view. Then, the sealing material is UV-cured by ultraviolet irradiation and then heat-cured by heat treatment. This inhibits leakage of the liquid crystal composition to the outside through the sealing material and increases the adhesion strength of the sealing material. A liquid crystal display device including the liquid crystal layer formed by a one-drop-fill method includes a sealing member without a sealing port between the first substrate 100 and the second substrate 200.

When the liquid crystal layer is formed by the one-drop-fill method, the uncured sealing material and the liquid crystal composition come into contact with each other. This may decrease the reliability of the liquid crystal display device. However, in the liquid crystal display device 1 according to the present embodiment that includes, in sequence, the backlight 20, the first substrate 100 including the color filter layer 110C, the liquid crystal layer 300 containing the liquid crystal composition that contains the first liquid crystal compound, and the second substrate 200, even when the liquid crystal layer is formed by the one-drop-fill method, in other words, even in the case where the sealing member for sealing the liquid crystal layer 300 is disposed between the first substrate 100 and the second substrate 200 and where the sealing member has no sealing port, a decrease in the reliability of the liquid crystal display device 1 can be reduced.

The first alignment film and the second alignment film have the function of controlling the alignment of the liquid crystal compound contained in the liquid crystal layer 300. Each of the first alignment film and the second alignment film is a homeotropic alignment film or a homogeneous alignment film, the homeotropic alignment film being configured to control the liquid crystal compound in the liquid crystal layer 300 in the pixel regions to be aligned in a direction perpendicular to a principal surface of each of the first substrate 100 and the second substrate 200, the homogeneous alignment film being configured to control the liquid crystal compound to be aligned in a direction parallel to the principal surface, when a voltage applied to the liquid crystal layer 300 is less than the threshold voltage (including no voltage application).

The fact that the liquid crystal compound is aligned in the direction perpendicular to the principal surface of each substrate indicates that the pretilt angle of the liquid crystal compound is about 86° to about 90°, preferably about 87° to about 89°, more preferably about 87.5° to about 89° with respect to the principal surface of the substrate. The fact that the liquid crystal compound is aligned in the direction parallel to the principal surface of the substrate indicates that the pretilt angle of the liquid crystal compound is about 0° to about 5°, preferably about 0° to about 2°, more preferably about 0° to about 1° with respect to the principal surface of the substrate. The pretilt angle of the liquid crystal compound indicates an angle at which the long axis of each molecule of the liquid crystal compound is inclined with respect to the principal surface of each substrate when no voltage is applied to the liquid crystal layer.

The first alignment film and the second alignment film are layers subjected to alignment treatment for controlling the alignment of the liquid crystal compound. Alignment films, such as polyimide films, typically used in the field of liquid crystal display devices can be used. Examples of the material of the first alignment film and the second alignment film include polymers each having a backbone chain derived from polyimide, polyamic acid, polysiloxane, or the like. A material, having a photoreactive site (functional group) in the backbone chain or a side chain, for a photo-alignment film is suitably used.

Each of the first alignment film and the second alignment film may be an aliphatic alignment film. That is, each of the first alignment film and the second alignment film may be an alignment film having an aliphatic group. In this case, energy transfer from the alignment films and the generation of radicals from the alignment films are inhibited, and the generation of radicals of the liquid crystal compound and the ionization of the liquid crystal compound can be inhibited, so that the VHR can be improved.

The first polarizer 410 and the second polarizer 420 are absorptive linear polarizers. Each of the first polarizer 410 and the second polarizer 420 is, for example, a polarizer (absorptive polarizer) obtained by dyeing a poly(vinyl alcohol) (PVA) film with an anisotropic material, such as an iodine complex (or dye), to adsorb the anisotropic material on the poly(vinyl alcohol) film, and subjecting the film to stretch alignment. Typically, in order to achieve high mechanical strength and high wet-heat resistance, each surface of the PVA film is laminated with a protective film, such as a triacetyl cellulose (TAC) film, for practical use.

The absorption axis of the first polarizer 410 and the absorption axis of the second polarizer 420 may be orthogonal to each other. In this case, the first polarizer 410 and the second polarizer 420 are arranged in crossed Nicols, so that a good black display state can be provided in a state where no voltage is applied.

In this specification, the fact that two axes (directions) are orthogonal to each other indicates that the angle (absolute value) between the axes is in the range of about 90°±about 3°, preferably in the range of about 90°±about 1°, more preferably in the range of about 90°±about 0.5°, particularly preferably about 90°.

The liquid crystal display device 1 further includes a source driver electrically coupled to the source lines, a gate driver electrically coupled to the gate lines, and a controller. The gate driver sequentially supplies scan signals to the gate lines under the control of the controller. The source driver supplies the data signals to the source lines under the control of the controller at the timing when the TFTs 120 are in a state where a voltage is applied by the scan signals. The potential of each of the pixel electrodes 130 is set in accordance with the data signal supplied through a corresponding one of the TFTs 120 to generate a longitudinal electric field between each pixel electrode 130 and the common electrode 220, thereby controlling the alignment of the liquid crystal compound in the liquid crystal layer 300. In the liquid crystal display device 1, the alignment state of the liquid crystal compound in each pixel is changed in accordance with the magnitude of the voltage applied to the liquid crystal layer 300 to adjust the light transmittance of the liquid crystal layer 300, thereby displaying an image.

The display mode of the liquid crystal display device 1 according to the present embodiment is not limited to a particular display mode. Examples of the display mode that can be used include longitudinal electric field modes, such as a vertical alignment (VA) mode and a twisted nematic (TN) mode; and transverse electric field modes, such as a fringe field switching (FFS) mode and an in-plane-switching (IPS) mode.

When the liquid crystal display device 1 is in the longitudinal electric field mode, the liquid crystal layer 300 contains a liquid crystal compound that is aligned in the direction perpendicular to the first substrate 100 and the second substrate 200 in a state where no voltage is applied. Each of the first alignment film and the second alignment film is a homeotropic alignment film.

When the liquid crystal display device 1 is in the transverse electric field mode, the liquid crystal layer 300 contains a liquid crystal compound that is aligned in the direction parallel to the first substrate 100 and the second substrate 200 in a state where no voltage is applied. Each of the first alignment film and the second alignment film is a homogeneous alignment film.

The backlight 20 may be any backlight that emits light to the liquid crystal panel 10, and may be a direct-lit backlight, an edge-lit backlight, or a backlight of any other type. The backlight 20 includes, for example, a light source, a light guide, and a reflector. The backlight 20 may further include an optical sheet, such as a diffuser or a prism sheet.

The liquid crystal display device 1 according to the present embodiment includes, in addition to the liquid crystal panel 10 and the backlight 20, components including: external circuits, such as a tape carrier package (TCP) and a printed-circuit board (PCB); optical films, such as a viewing angle-widening film and a luminance-improving film; and a bezel (frame). Such a component may be incorporated in another component depending on the type of component. Components other than the components described above are not limited, and those usually used in the field of liquid crystal display devices can be used. Thus, the description thereof is omitted.

### Second Embodiment

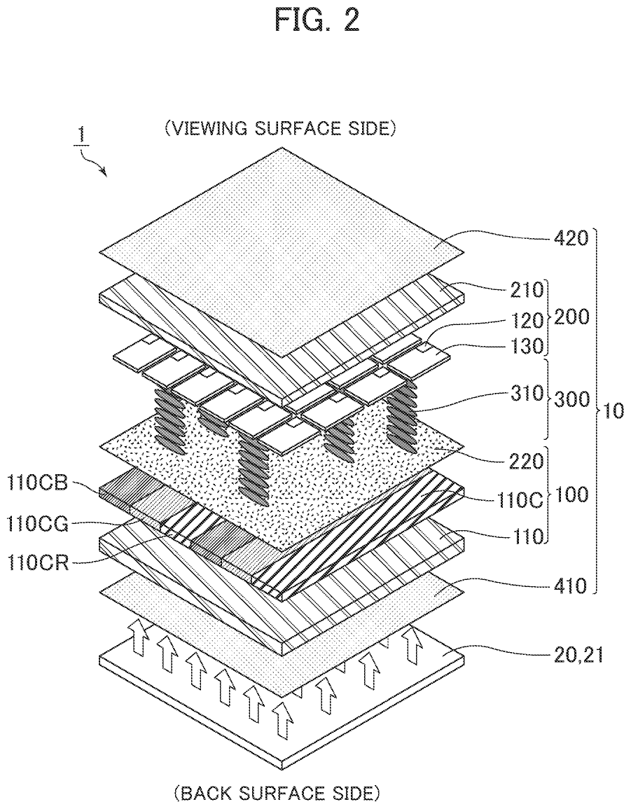

In the present embodiment, features specific to the present embodiment will be mainly described. Description of the same contents as those in the first embodiment will be omitted. FIG. 2 is a schematic cross-sectional view of a liquid crystal display device according to the second embodiment. In the first embodiment, the CF layer 110C and the TFTs 120 are arranged on the first substrate 100 side. As illustrated in FIG. 2, the TFTs 120 may be arranged on the second substrate 200 side. Also in this embodiment, the first substrate 100 including the color filter layer 110C is disposed on the back surface side of the liquid crystal layer 300. Thus, the intensity of light emitted from the backlight to the liquid crystal layer is about ⅓ or less of that in the typical structure. Accordingly, also in the present embodiment, it is possible to reduce a decrease in VHR while the response speed is increased.

In contrast to a liquid crystal display device in which a substrate (first substrate) disposed on the back surface side includes TFTs, a structure in which a substrate (second substrate) disposed on the viewing surface side includes TFTs as in the present embodiment is also referred to as an “inverted structure”.

In each of the COA structure of the first embodiment and the inverted structure according to the present embodiment, the color filter layer 110C is disposed closer to the backlight 20 (back surface side) than the liquid crystal layer 300. Accordingly, the intensity of light emitted from the backlight to the liquid crystal layer 300 can be reduced to, for example, about ⅓ or less, compared with a structure in which the color filter layer 110C is disposed closer to the viewing surface side than the liquid crystal layer 300.

While the present disclosure will be described in more detail below with reference to Examples and Comparative examples, the present disclosure is not limited only to these Examples.

### Example 1

A liquid crystal composition of Example 1 containing the following compounds was prepared: a liquid crystal compound having positive dielectric anisotropy and a structure represented by general formula (L6-1) described above (hereinafter, also referred to as a “cyano group-containing liquid crystal compound); and a liquid crystal compound having positive dielectric anisotropy and a structure represented by the following chemical formula (F-1) (hereinafter, also referred to as a “fluorine-containing liquid crystal compound”). The cyano group-containing liquid crystal compound content with respect to the total amount of liquid crystal composition of Example 1 was about 8% by weight.

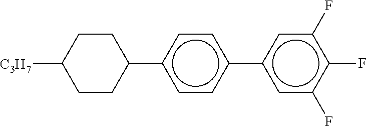

The liquid crystal panel 10 according to the first embodiment illustrated in FIG. 1 was formed in the following manner using the liquid crystal composition of Example 1 prepared as described above. The first substrate 100 was provided in which the color filter layer 110C, the TFTs 120, and the pixel electrodes 130 composed of ITO were disposed on a glass substrate serving as a first support substrate 110. The second substrate 200 was provided in which the common electrode 220 composed of ITO was disposed on a glass substrate serving as a second support substrate 210. Moreover, a first alignment film was formed on the pixel electrode 130 of the first substrate 100, and a second alignment film was formed on the common electrode 220 of the second substrate 200.

An ultraviolet-curable sealing material was applied to the surface of the first substrate on which the first alignment film was formed. The liquid crystal composition of Example 1 was dropped onto a predetermined position of the surface of the second substrate on which the second alignment film was formed. Subsequently, both substrates were bonded to each other in a vacuum. The sealing material was cured with ultraviolet light. Thereby, a liquid crystal cell of Example 1 was formed by a one-drop-fill method. The cell thickness (thickness of the liquid crystal layer 300) was about 3 μm. Since the liquid crystal layer 300 of Example 1 was formed by the one-drop-fill method, the liquid crystal display device of Example 1 had no sealing port.

### Reference Example 1

A liquid crystal cell of Reference example 1 was produced as in Example 1, except that the color filter layer was disposed on the second substrate side instead of the first substrate side.

### Comparative Example 1

A liquid crystal composition of Comparative example 1 having the same composition as the liquid crystal composition of Example 1 was prepared, except that the cyano group-containing liquid crystal compound was not contained, and only the fluorine-containing liquid crystal compound was contained. A liquid crystal cell of Comparative example 1 was produced as in Example 1, except that the liquid crystal composition of Comparative example 1 was used instead of the liquid crystal composition of Example 1, and the color filter layer was disposed on the second substrate side instead of the first substrate side.

### Measurement of VHR of Liquid Crystal Cell of Example 1, Reference Example 1, and Comparative Example 1

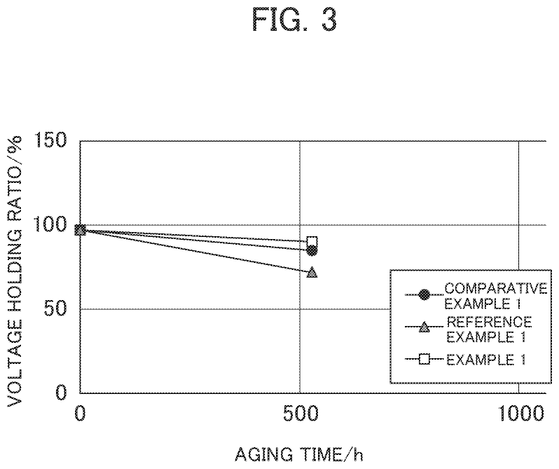

The voltage holding ratios (VHRs) of the liquid crystal cells of Example 1, Reference example 1, and Comparative example 1 were measured with a model 6254 VHR measurement system, available from Toyo Corporation, at about 1 V, about 1 Hz, and about 25° C. (aging time: about 0 h). A backlight exposure test was then performed in which each liquid crystal cell was exposed to light emitted from a backlight for about 500 hours in an environment with about 60° C. The VHR of each liquid crystal cell that has been subjected to the backlight exposure test was also measured under the same measurement conditions as those before the test (aging time: about 500 hours). FIG. 3 presents the results. FIG. 3 is a graph illustrating the results of VHR measurement in Example 1, Reference example 1, and Comparative example 1.

The backlight 20 used in the backlight exposure test had a luminance of about 5,000 nits. In Example 1 where the device had a COA structure, the color filter layer 110C was disposed between the liquid crystal layer 300 and the backlight 20. This structure presumably allowed the color filter layer 110C to absorb part of light emitted from the backlight 20 to reduce the intensity of light incident on the liquid crystal layer 300 to about ⅓ of those in Reference example 1 and Comparative example 1. Light with a luminance of about 5,000 nits from the backlight was thus incident on the liquid crystal layers of Reference Example 1 and Comparative Example 1, whereas light with a luminance of about 1,700 nits was presumably incident on the liquid crystal layer of Example 1.

FIG. 3 indicates that a decrease in VHR in Example 1 after aging was smaller than those in Reference example 1 and Comparative example 1.

### Example 2

A liquid crystal display device of Example 2 was produced as in Example 1, except that an FFS-mode electrode structure was used. Specifically, the planar common electrode 220 and the pixel electrodes 130 with slits were disposed over a first support substrate 110. The retardation of the liquid crystal layer 300 was about 300 nm.

### Comparative Example 2

A liquid crystal display device of Comparative example 2 was produced as in Example 2, except that the liquid crystal composition of Comparative example 1 was used. The retardation of the liquid crystal layer was 300 nm.

### Measurement of Response Speed of Liquid Crystal Cell of Example 2 and Comparative Example 2

A voltage of 5 V was applied to each of the liquid crystal cells of Example 2 and Comparative example 2. After that, the time taken for the normalized transmittance to change from 90% to 10% was measured. The results indicated that the response time of the cell of Example 2 was 77% of the response time of the cell of Comparative example 2 and the cell of Example 2 had improved response speed compared with the cell of Comparative example 2.

The above-described cyano group-containing liquid crystal compound has large refractive index anisotropy Δn, so that the cell thickness can be reduced. Accordingly, the use of the cyano group-containing liquid crystal compound enables a reduction in response time. The cyano group-containing liquid crystal compound has the property that the initial VHR is high but the VHR decreases due to backlight aging. In the liquid crystal panel having the COA structure or the inverted structure, the color filter layer is disposed between the liquid crystal layer and the backlight. Thus, the intensity of light from the backlight to the liquid crystal layer is about ⅓ or less of that of the typical structure. Thus, in each of Examples 1 and 2, the use of the COA structure enabled an improvement in response speed while a decrease in VHR was reduced, even when the liquid crystal composition containing a cyano group-containing liquid crystal compound was used. Specifically, in each of the liquid crystal panels of Examples 1 and 2, in which the liquid crystal composition containing the cyano group-containing liquid crystal compound was used in each liquid crystal panel having the COA structure, it was found that each panel was able to have reliability comparable to or higher than the panel of Comparative example 1 against the backlight aging for 500 hours, and the response time was able to be reduced by 23% compared with the panel of Comparative example 2.

The present disclosure contains subject matter related to that disclosed in Japanese Priority Patent Application JP 2022-053853 filed in the Japan Patent Office on Mar. 29, 2022, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device, comprising, in sequence:
a backlight;
a first substrate including a color filter layer;
a liquid crystal layer containing a liquid crystal composition; and
a second substrate,
wherein the liquid crystal composition contains a liquid crystal compound having a phenyl group and a conjugated bond group, the phenyl group having a halogen atom substituted for at least one hydrogen atom, and the conjugated bond group being conjugated with the phenyl group to form a continuous conjugated system.

2. The liquid crystal display device according to claim 1, wherein the liquid crystal composition contains 3% or more by weight of the liquid crystal compound.

3. The liquid crystal display device according to claim 2, wherein the liquid crystal composition contains 10% or more by weight of the liquid crystal compound.

4. The liquid crystal display device according to claim 1, wherein the liquid crystal compound has at least one of partial structures represented by the following general formulae (L1) to (L6): 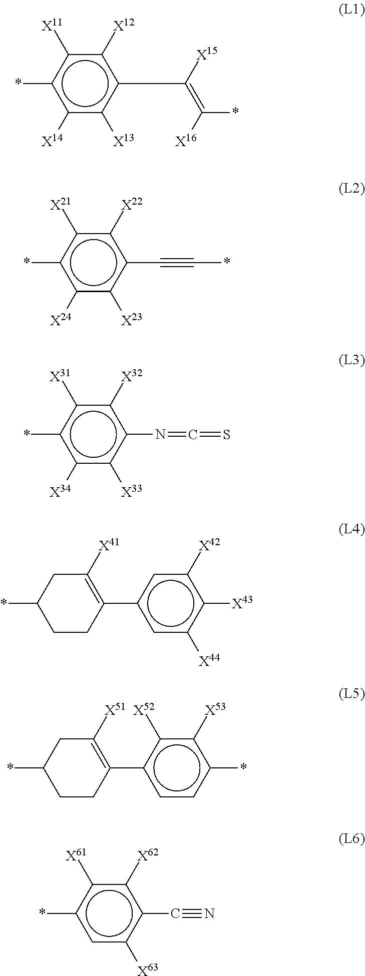
where in the above general formulae (L1) to (L6), X¹¹ to X¹⁶, X²¹ to X²⁴, X³¹ to X³⁴, X⁴¹ to X⁴⁴, X⁵¹ to X⁵³, and X⁶¹ to X⁶³ are each independently a hydrogen atom or a halogen atom, at least one of X¹¹ to X¹⁴ is a halogen atom, at least one of X²¹ to X²⁴ is a halogen atom, at least one of X³¹ to X³⁴ is a halogen atom, at least one of X⁴² to X⁴⁴ is a halogen atom, at least one of X⁵² or X⁵³ is a halogen atom, at least one of X⁶¹ to X⁶³ is a halogen atom, and each * is a binding position.

5. The liquid crystal display device according to claim 1, wherein the liquid crystal compound is a first liquid crystal compound, and
the liquid crystal composition further contains a second liquid crystal compound having an alkenyl group that does not form a conjugated system.

6. The liquid crystal display device according to claim 5, wherein the liquid crystal composition contains 51% or more by weight of the second liquid crystal compound.

7. The liquid crystal display device according to claim 6, wherein the liquid crystal composition contains 70% or more by weight of the second liquid crystal compound.

8. The liquid crystal display device according to claim 5, wherein the second liquid crystal compound has at least one of partial structures represented by the following general formulae (L7) and (L8): 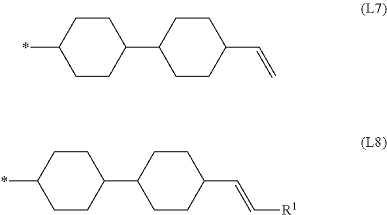
where R¹ in general formula (L8) is an alkyl group having 1 to 3 carbon atoms, and each * is a binding position.

9. The liquid crystal display device according to claim 1, further comprising:
a sealing member disposed between the first substrate and the second substrate, the sealing member enclosing the liquid crystal layer,
wherein the sealing member has no sealing port.
